(19) United States
(12) Patent Application Publication
(10) Pub. No.: US 2023/0380042 A1
(43) Pub. Date: Nov. 23, 2023

(54) SENSOR-BASED LIGHT SOURCE ACTIVATION

(71) Applicant: Hewlett-Packard Development Company, L.P., Spring, TX (US)

(72) Inventors: Hung Hua Peng, Taipei (TW); Rajesh A. Shah, Spring, TX (US); Wan-Chieh Lu, Taipei (TW)

(21) Appl. No.: 17/749,245

(22) Filed: May 20, 2022

(51) Int. Cl. H05B 47/17; H05B 47/11; H05B 47/115; H05B 47/14

(52) U.S. Cl. CPC H05B 47/17; H05B 47/11; H05B 47/115; H05B 47/14

(57) ABSTRACT

In an example, an electronic device may include a battery, a charging port to receive electrical power from an external power source to charge the battery, a light source disposed proximate to the charging port, a sensor to monitor a parameter related to an operational environment of the electronic device, and a processor to activate the light source based on the monitored parameter.

### BACKGROUND

The emergence and popularity of mobile computing has made portable electronic devices, due to their compact design and light weight, a staple in today's marketplace. An example electronic device may include a notebook computer, a tablet computer, a convertible device, and the like. Due in part to their mobile nature, such electronic devices may often be provided with rechargeable batteries. The rechargeable batteries may be used to operate the electronic devices. Further, the batteries of the electronic device may be charged by connecting a charging port of the electronic device to an external power supply.

### BRIEF DESCRIPTION OF THE DRAWINGS

Examples are described in the following detailed description and in reference to the drawings, in which:

FIG. 1 is a block diagram of an example electronic device, including a processor to activate a light source that is disposed proximate to a charging port based on a monitored parameter;

FIG. 2 is a schematic representation of an example electronic device, including a processor to activate a light source based on a movement of the electronic device and an ambient light surrounding the electronic device;

FIG. 3 is a block diagram of an example electronic device including a non-transitory computer-readable storage medium, storing instructions to activate a light source in response to detecting a movement of the electronic device; and

FIG. 4 is a flow diagram illustrating an example computer-implemented method for activating a light source based on a movement of an electronic device and an ambient light surrounding the electronic device;

### DETAILED DESCRIPTION

Electronic devices, such as mobile phones, personal digital assistants (PDAs), and laptop computers, are widely used. Such electronic devices use rechargeable batteries as power supplies. The rechargeable batteries may be connected to a source of electrical energy such as a wall outlet to charge the batteries. As an example, such rechargeable batteries may have to be frequently charged to provide the power to operate the electronic devices. Further, the electronic devices may be provided with charging devices (e.g., charging adapters) for charging the rechargeable batteries. Such charging devices are plugged into a socket (e.g., the wall outlet) and are coupled to the electronic devices to be charged. Furthermore, the electronic devices may include charge indicators electronically connected to the rechargeable batteries for indicating charge statuses of the rechargeable batteries. The charge indicators (e.g., a light source such as a light emitting diode (LED)) may be positioned proximate to a charging port, for instance.

Further, the charge indicator may indicate whether the electronic device is currently being charged, whether the battery is fully charged, or whether the electronic device is disconnected from the charging device. In an example, the charge indicator may be an LED that turns on when the electronic device is connected to the source of electrical energy and turns off when the electronic device is disconnected from the source of electrical energy. In another example, the charge indicator may indicate via a blinking pattern of the LED (e.g., blinking means charging, and no blinking means charged), or via a color of the indicator light (e.g., red means charging, and blue means charged).

Thus, the electronic devices can be charged by connecting the charging port of the electronic device to the source of electrical energy via the charging device (e.g., a charging adapter and a charging cable). However, in some scenarios such as a low light condition around the electronic device, the charging port may not be visible and hence a significant amount of time may be consumed in locating the charging port for connecting the charging cable. For example, consider that the electronic device has to be charged in a dark room (e.g., at night). Turning on a light to charge the electronic device may interrupt others resting in the room. Further, even when an approximate location of the charging port is known, a user may find it difficult to connect the charging cable to the charging port in the low light conditions. Hence, locating the charging port to connect the charging cable in the low light conditions can be challenging.

Examples described herein may provide an electronic device including a battery, a charging port to receive electrical power from an external power source to charge the battery, and a light source disposed proximate to the charging port. The light source (e.g., an LED) may indicate a charging status of the battery. Further, the electronic device may include a sensor to monitor a parameter related to an operational environment of the electronic device. In an example, the sensor monitors an ambient light in a location of the electronic device, detect a movement of the electronic device, or a combination thereof. Furthermore, the electronic device may include a processor to activate the light source that is proximate to the charging port based on the monitored parameter. Thus, examples described herein may facilitate users to locate or view the charging port and to connect the external power supply in low light conditions.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

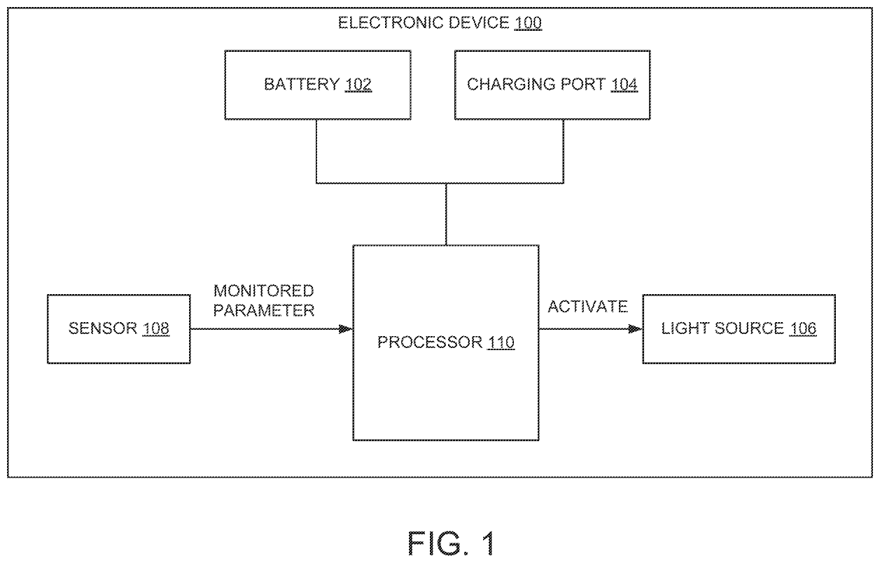

Turning now to the figures, FIG. 1 is a block diagram of an example electronic device 100, including a processor 110 to activate a light source 106 that is disposed proximate to a charging port 104 based on a monitored parameter. Example electronic device 100 can be a laptop, a desktop, a smartphone, a tablet, or any other device that includes charging port 104 and light source 106 (e.g., a light emitting diode (LED)) to indicate a charging status of electronic device 100.

As shown in FIG. 1, electronic device 100 includes a battery 102. Battery 102 may be a rechargeable battery or a battery pack including multiple rechargeable batteries. For example, battery 102 includes an electrochemical battery or a battery employing any other battery technology.

Further, electronic device 100 includes charging port 104 to receive electrical power from an external power source to charge battery 102. The external power source may be a source of alternating current (AC) electricity such as a wall outlet. Charging port 104 may be connected to the external power source, and may deliver power, which is supplied from the external power source to battery 102. Further, battery 102 may receive the power from the external power source through charging port 104. In some examples, charging port 104 is connected to the external power source via a charging adapter. The charging adapter may convert the AC electricity from the wall outlet (i.e., the charging adapter's input power from the external power source) into a direct current (DC) power supply (i.e., the charging adapter's output power) for electronic device 100. For example, charging port 104 includes a universal serial bus (USB) type-A port, a USB type-B port, a USB type-C port, a lightning port, a direct current (DC) power jack, or the like.

Further, electronic device 100 includes light source 106 disposed proximate to charging port 104. Light source 106 may be an indicator light (e.g., an LED) which is arranged to indicate the charging status of battery 102. Electronic device 100 may indicate the charging status via a blinking pattern of the indicator light (e.g., blinking means charging and no blinking means charged) or via a color of the indicator light (e.g., red means charging and blue means charged). Further, light source 106 may be turned off when electronic device 100 is electrically disconnected from the external power source.

Furthermore, electronic device 100 includes a sensor 108 and processor 110. As used herein, the term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 110 may, for example, include single or multiple cores on a chip, multiple cores across multiple chips, multiple cores across multiple devices, or suitable combinations thereof. Processor 110 may be functional to fetch, decode, and execute instructions as described herein.

Further, sensor 108 may be a device to monitor an operational environment of electronic device 100. In an example, sensor 108 includes a motion sensor to detect a movement of electronic device 100. In another example, sensor 108 includes an ambient light sensor to detect an ambient light in the location of electronic device 100. In an example, battery 102, charging port 104, light source 106, sensor 108, and processor 110 are communicatively connected to each other via a motherboard of electronic device 100.

During operation, sensor 108 may monitor a parameter related to the operational environment of electronic device 100. In an example, processor 110 causes sensor 108 to monitor the parameter related to the operational environment when electronic device 100 is powered-on and operational (e.g., a working state “S0”). The working state may refer to a power state in which electronic device 100 may be awake and running.

In other examples, processor 110 determines that electronic device 100 is operating on the battery power. In response to determining that the electronic device is operating on the battery power, processor 110 may cause sensor 108 to monitor the parameter related to the operational environment. When electronic device 100 is receiving the power from the external power supply, processor 110 may not trigger monitoring of the parameter related to the operational environment.

Further, processor 110 may activate light source 106 based on the monitored parameter. In an example, processor 110 may activate light source 106 in response to detecting the movement of electronic device 100. In another example, processor 110 may activate light source 106 in response to detecting that the ambient light is less than a threshold. In this example, light source 106, when activated, may act as a search light to visually locate charging port 104 and facilitate a user to connect the charging adapter to charging port 104. In another example, light source 106, when activated, may act as the search light to visually locate the charging adapter.

Further, processor 110 may initiate a timer defining a timeout period upon activating light source 106 based on the monitored parameter. Processor 110 may turn-off light source 106 in response to an expiration of the timer. Thus, light source 106 can be activated for a period of time to locate charging port 104, the charging adaptor, or a combination thereof.

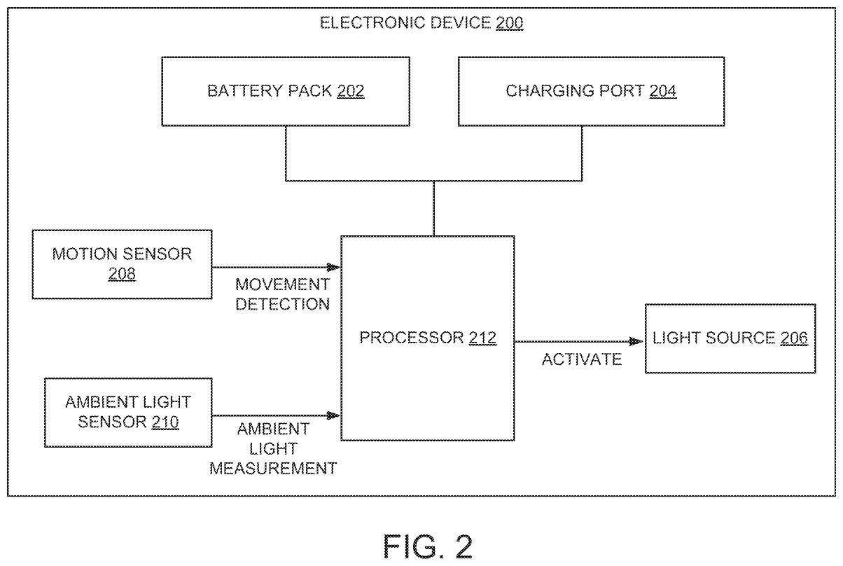

FIG. 2 is a schematic representation of an example electronic device 200, including a processor 212 to activate a light source 206 based on a movement of electronic device 200 and an ambient light surrounding electronic device 200. An example electronic device 200 includes a display housing including a display screen. Further, electronic device 200 may include a base housing pivotally connected to the display housing. The base housing may include a keyboard, a touch pad, and the like.

Further, electronic device 200 may include a battery pack 202, a charging port 204, light source 206, a motion sensor 208, an ambient light sensor 210, and processor 212. For example, battery pack 202 may be a rechargeable battery pack with a built-in battery management system (BMS), for use in electronic device 200. Further, battery pack 202 may include a battery. The battery may refer to a hardware device that supplies power to electronic device 200, enabling electronic device 200 to operate without being connected to an external power supply. Further, the battery may include multiple cells connected in serial configuration, parallel configuration, or a combination thereof.

Further, charging port 204 may receive electrical power from the external power source to charge battery pack 202. In an example, charging port 204 may be connected to the external power source via a charging adapter that includes a charging cable. Furthermore, light source 206 may be disposed proximate to charging port 204. Light source 206 may indicate a charging status of battery pack 202. In an example, battery pack 202, charging port 204, light source 206, motion sensor 208, ambient light sensor 210, and processor 212 are communicatively connected to each other via a motherboard of electronic device 200.

During operation, motion sensor 208 may detect a movement of electronic device 200. In an example, processor 212 causes motion sensor 208 to detect the movement of electronic device 200 (e.g., an on-lap movement detection) while electronic device 200 is in a powered-on and functional state (e.g., working state (S0)). In another example, processor 212 causes motion sensor 208 to detect the movement of electronic device 200 (e.g., a pick-up movement detection) while electronic device 200 is in a power saving state. An example power saving state is a sleep state (e.g., S1, S2, or S3), a hibernate state (S4), or a soft-off state (S5). In an advanced configuration and power interface (ACPI), power states S1 to S4 states are defined as sleeping states (i.e., power saving states), the S0 state is defined as a power-on state, and the S5 state is defined as a power-off state. In such examples, processor 212 causes motion sensor 208 to detect the movement of electronic device 200 while electronic device 200 is in any of the S0 to S5 power states.

For example, motion sensor 208 detects various motion parameters such as acceleration, a speed, a rotation angle (e.g., a rotational angle of electronic device 200, a rotational angle of the display housing relative to the base housing of electronic device 200, or the like), a location, and the like of electronic device 200 in a three-dimensional (3D) space. Example motion sensor 208 includes an accelerometer, a gyroscope, or any sensor that detects the movement or orientation of electronic device 200.

In response to detecting the movement of electronic device 200, ambient light sensor 210 may measure an ambient light surrounding electronic device 200. For example, ambient light sensor 210 is used to detect whether electronic device 200 is operated in a dark environment in which an ambient light is not present. Further, ambient light sensor 210 may monitor light conditions surrounding electronic device 200, and notify, the light conditions to processor 212.

In response to a signal indicative of the ambient light less than a threshold from ambient light sensor 210, processor 212 may activate light source 206. In this example, upon detecting the movement of electronic device 200 and detecting that electronic device 200 is located in the dark environment (e.g., during night), processor 212 may activate (i.e., turn-on) light source 206 to facilitate a user to locate charging port 204, the charging adapter, or a combination thereof.

In some examples, processor 212 detects that electronic device 200 is operating on the battery power. In response to detecting the movement of electronic device 200, detecting that the ambient light is less than the threshold, and detecting that electronic device 200 is operating on the battery power, processor 212 may activate light source 206. Processor 212 may cause light source 206 to emit light having a characteristic that is different from that of an indication of the charging status of electronic device 200. An example characteristic includes a color, an intensity, a pattern, or any combination thereof. For example, in response to the signal indicative of the ambient light less than the threshold, processor 212 causes light source 206 to emit light having an intensity greater than that of the indication of the charging status of electronic device 200.

In other examples, processor 212 may also consider an amount of remaining battery power in addition to the movement detection and the ambient light detection to activate light source 206. In this example, processor 212 activates light source 206 when a percentage of remaining battery power is less than a threshold in addition to detecting the movement of electronic device 200 and detecting that the ambient light is less than the threshold.

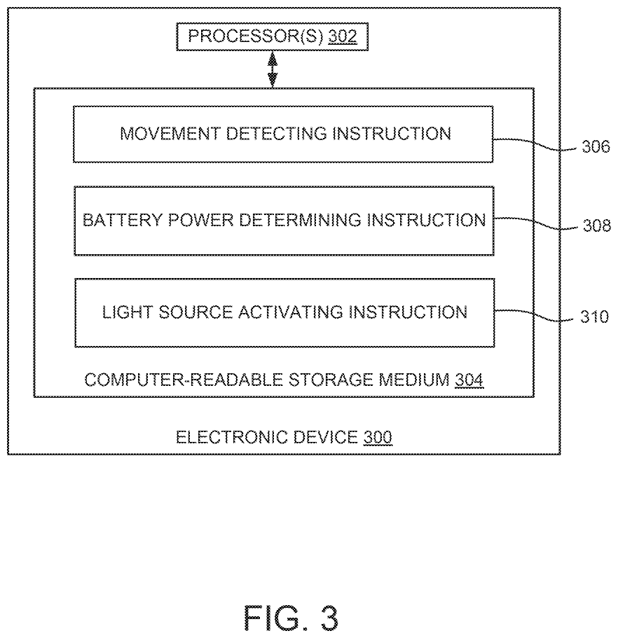

FIG. 3 is a block diagram of an example electronic device 300 including a non-transitory computer-readable storage medium 304, storing instructions to activate a light source in response to detecting a movement of electronic device 300. Electronic device 300 may include a processor 302 and computer-readable storage medium 304 communicatively coupled through a system bus. Processor 302 may be any type of central processing unit (CPU), microprocessor, or processing logic that interprets and executes computer-readable instructions stored in computer-readable storage medium 304.

Computer-readable storage medium 304 may be a random-access memory (RAM) or another type of dynamic storage device that may store information and computer-readable instructions that may be executed by processor 302. For example, computer-readable storage medium 304 may be synchronous DRAM (SDRAM), double data rate (DDR), Rambus® DRAM (RDRAM), Rambus® RAM, and the like, or storage memory media such as a floppy disk, a hard disk, a CD-ROM, a DVD, a pen drive, and the like. In an example, computer-readable storage medium 304 may be a non-transitory computer-readable medium, where the term “non-transitory” does not encompass transitory propagating signals. In an example, computer-readable storage medium 304 may be remote but accessible to electronic device 300.

Computer-readable storage medium 304 may store instructions 306, 308, and 310. Instructions 306 may be executed by processor 302 to detect a movement of electronic device 300 while electronic device 300 is in a power saving state. The power-saving state may be a standby state, a hibernate state, or a soft off state (i.e., a shutdown state).

Instructions 308 may be executed by processor 302 to determine that electronic device 300 is operating on battery power. In response to electronic device 300 is operating on the battery power and in response to detecting the movement of electronic device 300, instructions 310 may be executed by processor 302 to activate a light source disposed proximate to a charging port of electronic device 300. In an example, the light source disposed proximate to the charging port is activated for a period of time (e.g., 10 seconds).

In some examples, the light source is turned-on to indicate a charging status of the battery when electronic device 300 receives electrical power from an external power source via the charging port. The light source is turned-off when electronic device 300 is operating on the battery power. Such a light source that is disposed proximate to the charging port can also be activated to visually locate the charging port, a charging connector of a charging adapter, or both in low light conditions (e.g., a dark environment).

In an example, in response to electronic device 300 is operating on the battery power and in response to detecting the movement of electronic device 300, instructions 310 to activate the light source may include instructions to cause the light source to emit light having a characteristic different from that of an indication of the charging status of electronic device 300. An example characteristic may include a color, an intensity, a pattern, or any combination thereof.

In an example, instructions 310 to activate the light source includes instructions to activate the light source based on determining that the detected movement satisfies a criterion. An example criterion includes a magnitude of acceleration, a change in acceleration, a number of changes in acceleration, a predetermined pattern of acceleration changes, or any combination thereof. The criterion may be user-defined or determined based on a trained model.

Computer-readable storage medium 304 may further store instructions to measure an ambient light in a location of electronic device 300 in response to electronic device 300 is operating on the battery power. In response to detecting that the ambient light is less than a threshold, computer-readable storage medium 304 may include instructions to activate the light source disposed proximate to the charging port.

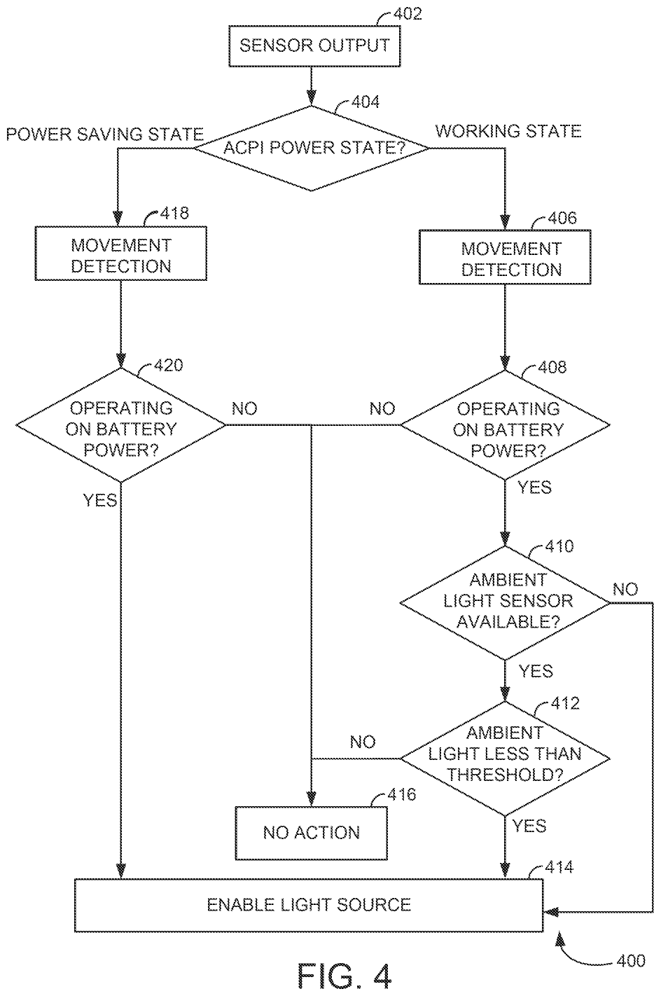

FIG. 4 is a flow diagram illustrating an example computer-implemented method 400 for activating a light source based on a movement of an electronic device and an ambient light surrounding the electronic device. Method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and to make decisions. Alternatively, method 400 may represent functions or actions performed by functionally equivalent circuits like analog circuits, digital signal processing circuits, application specific integrated circuits (ASICs), or other hardware components associated with the system. Furthermore, the flow chart is not intended to limit the implementation of the present application, but rather the flow chart illustrates functional information to design/fabricate circuits, generate computer-readable instructions, or use a combination of hardware and computer-readable instructions to perform the illustrated process.

At 402, an output from a system sensor may be received. The system sensor may indicate an ACPI power state of the electronic device. At 404, a check may be made to determine the ACPI power state of the electronic device. An example ACPI power state includes a working state (S0), a sleep state (S4), a shutdown state (S5), or the like. The working state (S0) may be a power-on state and the sleep state S4 (i.e., a hibernate state) may be a lowest-powered sleeping state and has a longest wake-up latency.

When the electronic device is in the working state, a movement of the electronic device is detected using a motion sensor, at 406. An example movement detection in the working state includes an on-lap movement detection of the electronic device (i.e., a user is using the electronic device (e.g., a laptop) while placing on the lap). At 408, a check is made to determine whether the electronic device is running on a battery power (i.e., the electronic device is disconnected from an external power supply).

When the electronic device is operating on the battery power, a check is made to determine whether an ambient light sensor is available in the electronic device, at 410. When the ambient light sensor is available, a check is made to determine whether an ambient light sensed by the ambient light sensor is less than a threshold, at 412. When the ambient light is less than the threshold or when the ambient light sensor is not available, the light source (e.g., a battery charge indicator LED) is enabled at 414, which may either visually locate a charging port or act as a reference to find the charging port.

When the electronic device is not operating on the battery power (i.e., when the electronic device is receiving electrical power from the external power source) or when the ambient light is not less than the threshold, the process may end without any further action, at 416.

When the electronic device is in a power saving state (e.g., S4 or S5 power saving state), a movement of the electronic device is detected using the motion sensor, at 418. The motion sensor may be in an active state to detect the movement of the electronic device even when the electronic device is in the power saving state. An example movement detection in the power saving state includes a user pick-up movement detection of the electronic device.

At 420, a check is made to determine whether the electronic device is running on the battery power. When the electronic device is operating on the battery power, the light source is enabled, at 414. In this example, the ambient light detection is not performed as the ambient light sensor may not work in the S4 or S5 power saving state. Further, when the electronic device is not operating on the battery power, method 400 may end without any further action, at 416.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
a battery;
a charging port to receive electrical power from an external power source to charge the battery;
a light source disposed proximate to the charging port;
a sensor to monitor a parameter related to an operational environment of the electronic device; and
a processor to activate the light source based on the monitored parameter.

2. The electronic device of claim 1, wherein the processor is to:
determine that the electronic device is operating on battery power; and
in response to determining that the electronic device is operating on the battery power, cause the sensor to monitor the parameter related to the operational environment.

3. The electronic device of claim 1, wherein the processor is to:
cause the sensor to monitor the parameter related to the operational environment when the electronic device is powered-on and operational.

4. The electronic device of claim 1, wherein the sensor comprises an ambient light sensor to detect an ambient light in a location of the electronic device, and wherein the processor is to activate the light source in response to detecting that the ambient light is less than a threshold.

5. The electronic device of claim 1, wherein the sensor comprises a motion sensor to detect a movement of the electronic device, and wherein the processor is to activate the light source in response to detecting the movement of the electronic device.

6. The electronic device of claim 1, wherein the processor is to:
initiate a timer defining a timeout period upon activating the light source based on the monitored parameter; and
turn-off the light source in response to an expiration of the timer.

7. An electronic device comprising:
a battery pack;
a charging port to receive electrical power from an external power source to charge the battery pack;
a light source disposed proximate to the charging port, wherein the light source is to indicate a charging status of the battery pack;
a motion sensor to detect a movement of the electronic device;
an ambient light sensor to measure an ambient light surrounding the electronic device in response to detecting the movement of the electronic device; and
a processor to activate the light source in response to a signal indicative of the ambient light less than a threshold from the ambient light sensor.

8. The electronic device of claim 7, wherein the processor is to:
detect that the electronic device is operating on battery power; and
activate the light source in response to the electronic device is operating on the battery power.

9. The electronic device of claim 7, wherein the processor is to:
cause the motion sensor to detect the movement of the electronic device while the electronic device is in a powered-on and functional state.

10. The electronic device of claim 7, wherein the processor is to:
cause the motion sensor to detect the movement of the electronic device while the electronic device is in a power saving state.

11. The electronic device of claim 7, wherein the processor is to cause the light source to emit light having a characteristic that is different from that of an indication of the charging status of the electronic device.

12. The electronic device of claim 11, wherein the characteristic comprises a color, an intensity, a pattern, or any combination thereof.

13. A non-transitory computer-readable storage medium storing instructions executable by a processor of an electronic device to:
detect a movement of the electronic device while the electronic device is in a power saving state;
determine that the electronic device is operating on battery power; and
in response to the electronic device is operating on the battery power and in response to detecting the movement of the electronic device, activate a light source disposed proximate to a charging port of the electronic device.

14. The non-transitory computer-readable storage medium of claim 13, wherein the power-saving state is one of a standby state, a hibernate state, and a soft off state.

15. The non-transitory computer-readable storage medium of claim 13, further comprising instructions to:
in response to the electronic device is operating on the battery power, measure an ambient light in a location of the electronic device; and
in response to detecting that the ambient light is less than a threshold, activate the light source disposed proximate to the charging port.

16. The non-transitory computer-readable storage medium of claim 13, wherein instructions to activate the light source comprise instructions to:
activate the light source based on determining that the detected movement satisfies a criterion.

17. The non-transitory computer-readable storage medium of claim 13, wherein the light source is turned-on to indicate a charging status of the battery when the electronic device receives electrical power from an external power source via the charging port, and wherein the light source is turned-off when the electronic device is operating on the battery power.

18. The non-transitory computer-readable storage medium of claim 17, wherein instructions to activate the light source comprise instructions to:
in response to the electronic device is operating on the battery power and in response to detecting the movement of the electronic device, cause the light source to emit light having a characteristic different from that of an indication of the charging status of the electronic device.

19. The non-transitory computer-readable storage medium of claim 18, wherein the characteristic comprises a color, an intensity, a pattern, or any combination thereof.

20. The non-transitory computer-readable storage medium of claim 13, wherein instructions to activate the light source comprise instructions to:
in response to the electronic device is operating on the battery power and in response to detecting the movement of the electronic device, activate the light source disposed proximate to the charging port for a period of time.
